(19) United States
(12) Patent Application Publication
(10) Pub. No.: US 2005/0197157 A1
(43) Pub. Date: Sep. 8, 2005

(54) System enabling easy application development on mobile devices

(76) Inventors: Wendong Li, Gainesville, FL (US); David Roger Nordstedt, Gainesville, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/779,561

(22) Filed: Feb. 13, 2004

(51) Int. Cl. H04M 1/00

(52) U.S. Cl. 455/556.2

(57) ABSTRACT

A system operable on a small mobile device such as a smart phone uses descriptive languages with a similar style to markup languages used in a thin client but having features characteristic of a fat client. In one form, the system could be a MIDlet on J2ME platform or an executable program on Microsoft Smartphone platform that allows developers to mobilize business applications without the knowledge of complicated J2ME/MIDlet or Microsoft development environments. The system includes an XML language and a Script Language. Applications written in the Script Language can be translated to XML and then optionally compiled to embedded code which can be parsed and interpreted easily and efficiently by the system.

### BACKGROUND OF THE INVENTION—DESCRIPTION OF PRIOR ART

1.1 Introduction

Many computer applications have been developed and used by enterprises, governments, and consumers. Internet that has reached almost everywhere helps to augment these applications to be more pervasive and powerful. As the number of mobile devices such as cell phones and PDAs are growing to surpass personal computers, many applications need to be mobilized and developed on these small devices. Moreover the capacity of the wireless communication and these mobile devices has been increasing rapidly, these all push the demand for fast and easy development of sophisticated mobile applications to be highly urgent.

Currently, applications on mobile devices are developed in one of the two major ways: fat client approach by procedural programming languages or thin client approach by descriptive markup languages. All programming language or markup language approaches are assisted by various tools on different platforms. The most popular procedural programming language used for mobile devices is J2ME (Java 2 Micro Edition) [Giguere 2000]. Another influential one is C/C++ in .Net Compact Framework or on Microsoft Smartphone platform [MS 2002]. Other significant platforms include BREW, Symbian, Palm, embedded Linux, RIM, etc.

FIG. 1 shows the current approach of J2ME. An application developed using J2ME running on mobile devices is called MIDlet. Each application will result in a package of MIDlet software for downloading and installing on mobile devices. Applications developed using other programming languages is similar to this J2ME approach as show in this figure. We just use J2ME to illustrate the principles through out this application.

For the thin client approach, the most popular markup language is WML/WAP[WAP Forum 2002]. Compact HTML (cHTML) that is used successfully by NTT DoComo is another popular one FIG. 2 uses WML/WAP version 1 to show the markup language approach. WML is a markup language in WAP protocol for wireless devices. cHTML by NTT DoCoMo is a simplified version of HTML. New WML 2.0 for WAP 2.0 supports Basic xHTML and WML 1× backward compactable. Some browsers on mobile devices can even support full HTML.

1.2 Problems

The fat client approach gives developers the power to develop applications from lower level with less restriction. Usually, users will have much better experience with applications developed by procedural programming languages [Yospace 2002]. The disadvantage is also brought in from the lower level approach. Any change to the applications developed by procedural programming languages will force some components or even the entire executable package to be recompiled and re-installed. Since these applications are developed using procedural computer programming languages, like J2ME, only well trained programmers can understand and be able to extend, change, and even install and uninstall the application executables, such as MIDlet in the J2mE case. Therefore this kind of application development and update on mobile devices are hard and very costly.

Further more, lower level programming in procedural languages usually involves harder-to-find bugs and results in less reliable systems. Even good programmers prefer high level programming for high productivity.

On the other hand, the thin client approach in markup languages is easier and faster for simple application development. But its power is restricted by the magnitude of these languages and on small mobile devices these languages usually support only a few features.

Just as in the wired Internet world, Network Computer (NC) failed; WAP version 1 with WML version I also failed. A NC was conceived as a thin client, diskless, cheap computer mainly used to browse the Web and assumes almost all applications are Web based and heavily relied on servers to handle almost everything. Proposed advantages of NC included lower maintenance cost, easy application deployment, easy software and environment update. But as the PC is much more powerful than the NC and many applications ran much better locally on the PC, the NC died very fast. This history shows how valuable fat clients are. As long as allowed, users always like to have fat client applications because of their quality. Since markup languages are predefined, and tailored to support very few features to fit small mobile devices, any features not supported by WML will not be available to users. Users often cannot be satisfied with the thin client approach using markup languages and therefore the fat client approach is required and J2ME actually came after WAP and its WML language.

In viewing the two approaches, there should be a technology to overcome their disadvantages and at the same time to draw advantages from both fat client approach and thin client approach. The invention described in this patent application is innovated for this purpose.

1.3 Reference

Giguere, E., Java 2 Micro Edition: Professional Developer's Guide. John Wiley & Sons. New York; 2000.
Yospace 2002, Getting the User Experience Right for Wireless. http://www.wmrc.com/businessbriefing/pdf/wireless2002/technology/Yospace.pdf.
Microsoft 2002, Smartphones. http://www.microsoft.com/mobile/smartphone/
WAP Forum 2002, WAP White Papers, WAP Architecture, WML, and WTLS Specifications. http://www.wapforum.org/what/technical.htm

### SUMMARY OF THE INVENTION

1.4 The Summary

The present invention is about a system on a small mobile device such as a smart phone with a technology we call xPhoneApp. The word xPhoneApp represents eXtensible Phone Application. And therefore we can call the system an xPhoneApp Engine. By using the xPhoneApp technology, the disadvantages of current fat client approach due to its reliance on procedural programming languages can be overcome. Similarly, the disadvantages of the current thin client approach due to its elimination of powerful features can also be overcome. XPhoneApp uses descriptive languages with the similar style to those markup languages used in the thin client approach. Unlike thin client approach, however, the xPhoneApp Engine and its descriptive languages are more powerful and have richer features so that fat client applications can be developed based on them.

XPhoneApp Engine could be a MIDlet on J2ME platform or an executable program on Microsoft Smartphone platform, etc., that allows developers to mobilize business applications without the knowledge of complicated J2ME/MIDlet or Microsoft development environments. The technology can significantly increase the speed of mobile application development.

XPhoneApp descriptive languages include an XML language XphML and anther language called Phai (Phoneomeno Application Interpreter) Script Language. Applications written in the Phai Script Language, will be translated to XphML and then optionally compiled to Phai embedded code which can be parsed and interpreted easily and efficiently by the xPhoneApp Engine.

Describing the invention in terms of J2ME will not lose its generality in other environments such as the Microsoft environment. We use J2ME just for its simplicity. Not mentioning other platforms implies they all have similar behaviors unless explicitly indicated otherwise. This way we can present the invention in a clearer, more concrete and understandable fashion.

FIG. 3 illustrates the architecture and environment of xPhoneApp. In the context of J2ME, the xPhoneApp Engine will be a MIDlet. Each mobile device will have an xPhoneApp Engine that takes scripts of the applications in XphML or Phai embedded code from remote server. Applications are originally developed in XphML or Phai Script Language. Scripts in Phai Script Language will be compiled or translated to Phai embedded code. The XphML/Phai scripts are descriptive and much easier to learn and write. This makes the application development, extension, modification much easier, faster and cost-effective. XphML and Phai Script Language are extendable and conveniently customizable. This enables more power and applicability than thin client approach by markup up languages.

FIG. 4 illustrates that the XphML/Phai code can be stored locally. Fat client applications often work in this way independent of communication and server. This is a major difference from the thin client approach in markup languages.

1.5 Advantages

The advantages of xPhoneApp in comparison with the fat client approach by procedural programming languages and the thin client approach by markup languages of the prior art are summarized as following:
Speed up of application development. Development of new applications is fast; when applications are deployed to enterprise customers, customization efforts are very little; and adding new features to the applications is easy and fast, too.
Reduction of expertise requirement for application change and extension. Even non-programming experts can modify and customize applications running on mobile devices in xPhoneApp environment that is XML based. Most companies have their own IT staff well-trained and knowledgeable on how to develop Web-based applications. With xPhoneApp, the current IT teams will be able to use their same skill set on web development to perform simple changes and extensions to mobile applications.
Alleviation of portability problems. Usually, applications developed in procedural programming languages have portability problems. Even for J2ME, which is designed for platform independence, different computing and memory capability of the various handsets will force modification of applications. When applications are developed using xPhoneApp, almost no modification is required. Even in rare cases where it is needed, it is much simpler to modify xPhoneApp scripts.
Personalization of application. For example, in a hospital application we can offer different levels of access and functionality to different physicians, nurses, specialists, etc.
Elimination of dependence on communication and server. Applications can optionally be totally installed locally on mobile devices, or partially installed on mobile devices and partially loaded from servers as the applications run, or all application scripts are from servers on the fly.
Utilization of local functions and resources. Applications can use extended features only supported and available locally on mobile devices, such as GPS, voice enabled input, local persistent storage, etc.
Boost of reliability. The system reliability in xPhoneApp environment mainly rely on the xPhoneApp Engine. Extensively tested xPhoneApp Engine can assure increased reliability of all applications.
Support of iLBS (impromptu Location Based Services). Only xPhoneApp Engine is required to be pre-installed on mobile devices. When the devices are in a new location, new applications particular to that location can be detected, then users can either download these applications or access then on the fly.

### BRIEF DESCRIPTION OF THE DRAWINGS

The accompanying drawings assist to describe the features of the invention more clearly.

FIG. 1 is a diagram illustrating the architecture and environment of fat client approach in procedural programming language by J2ME MIDlet.

FIG. 2 is a diagram illustrating the architecture and environment of thin client approach by markup language WML in WAP 1.0.

FIG. 3 is a diagram illustrating the architecture of the invention when xPhoneApp applications in XphML or PhaiEmL code are downloaded from remote servers.

FIG. 4 is a diagram illustrating the architecture of the invention when xPhoneApp applications in XpnML or Phai PhaiEmL code are at local mobile devices in the Record Management System (RMS).

FIG. 5 is a diagram illustrating some components of the system of the invention for pure XphML approach.

FIG. 6 is a diagram illustrating some components of the system of the invention for the approach with both XphML and PhaiEmL.

FIG. 7 is a diagram illustrating components of the xPhoneApp Engine of the invention on mobile devices.

FIG. 8 is a diagram of a series of screens of the first version of a hospital application.

FIG. 9 is a diagram of a series of screens of the second version of the hospital application.

FIG. 10 is a diagram illustrating J2ME CLDC/MIDP GUI components related to the system of the invention

FIG. 11 is a diagram illustrating Microsoft Smartphone 2002 Controls for GUI related to the system of the invention

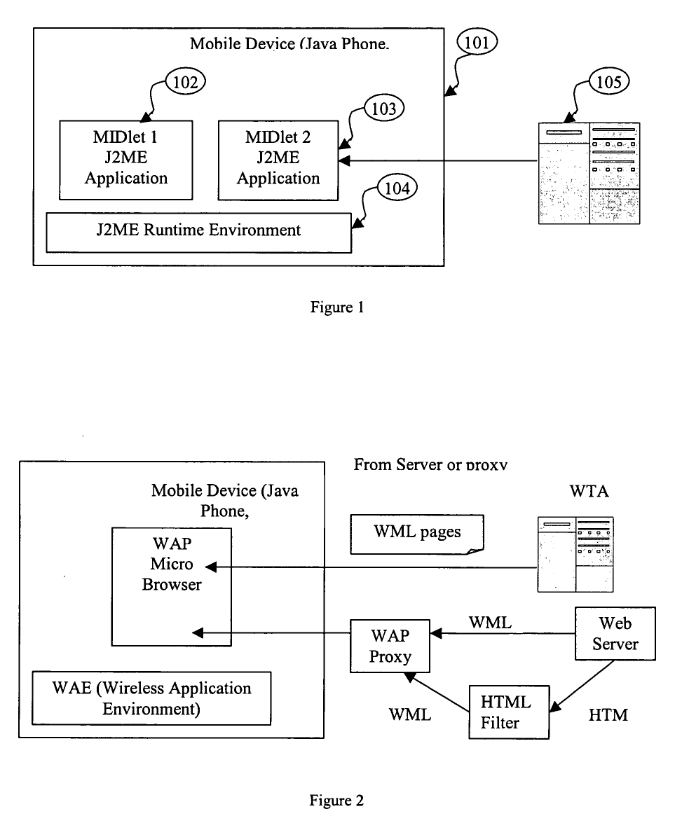

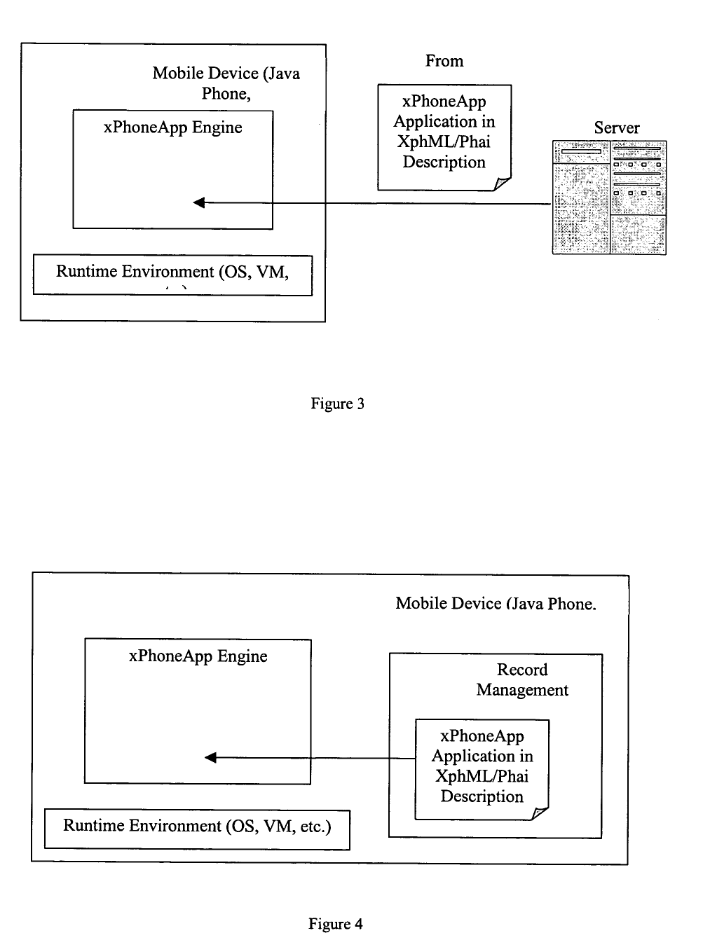

### DETAILED DESCRIPTION OF THE INVENTION

The invention will be presented in details in terms of system architecture, system components, and system development -deployment-and-installation process for xPhoneApp Engine.

1.6 Architecture

The xPhoneApp technology can have two similar approaches. One uses more machine oriented embedded language and the other just uses XML. We will present them one by one.

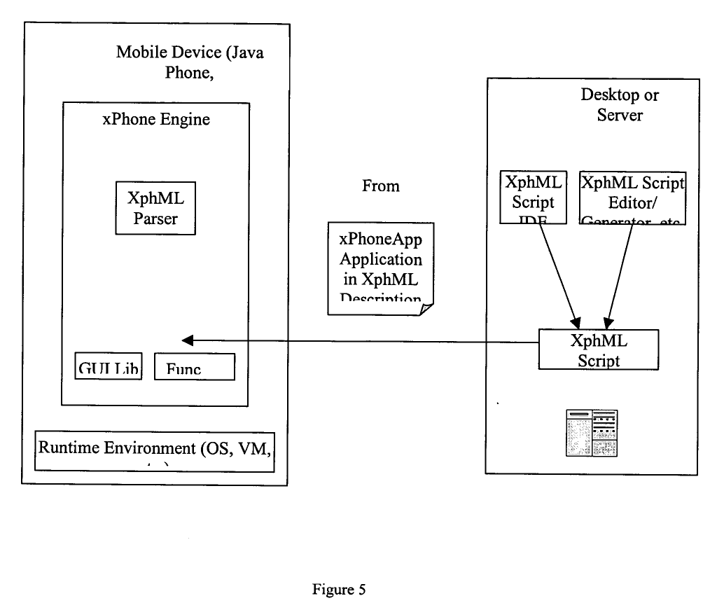

FIG. 5 shows the architecture for the pure XML approach. The XML language with all its rules and format used in xPhoneApp is named XphML. Users write applications in XphML description directly through graphic IDE, primitive editors, or indirectly generated by other programs such as Perl scripts, Java servlets, or Microsoft ASP. Desktop computers for development and computers for script generation usually are physically different than the servers from which the XphML scripts are loaded to the xPhoneApp Engine. The xPhoneApp technology also provides an XphML checker to check correctness and validation which can be static manually and automatically invoked by XphML tools such as IDE or script generator. The xPhoneApp engine on mobile devices (client side as we often refer to) interprets the XphML scripts and performs all operations as required. Standard core Graphical User Interface (GUI) library and other functionality library are part of the xPhoneApp to fulfill the required actions.

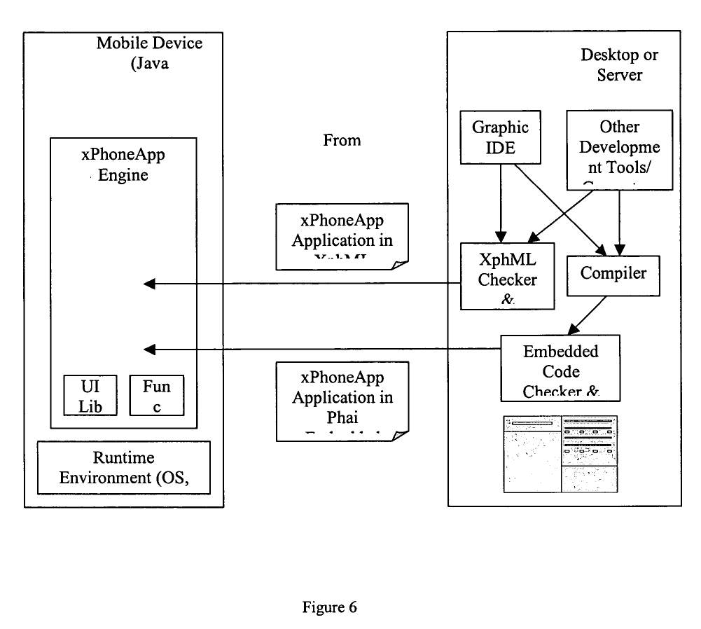

FIG. 6 shows the architecture for the Phoneomena Application Interpreter (Phai) approach where a machine friendly embedded language is optional. Users write applications in XphML directly through graphic IDE, primitive editors, various development tools, or indirectly generated by other programs such as Perl scripts, Java servlets, or Microsoft ASP. The XphMI scripts can be checked for correctness and validation. Then they can be send directly to client mobile devices or can be further “compiled” to Phai Embedded Language (PhaiEmL) code. The code in PhaiEmL can also be checked for correctness and be compacted. The xPhoneApp Engine on mobile devices interpretes the XphML or PhaiEmL scripts and perform operations as required. GUI library and other functionality library are the same as the XphML only approach.

Just as FIG. 4 shows, many things such as scripts in XphML or PhaiEmL, intermediate data, etc. can be cached and stored locally on client mobile devices for better performance if the application can be hampered be high communication overhead. In some cases, no communication to servers is needed at all.

1.7 The XML for xPhoneApp—XphML

For both pure XphML and PhaiEmL approaches, XphML is the core. Its features and capability define the features and capability of XphoneApp technology and all its components. An example is used to illustrate the principles and implementation characteristics.

1.7.1 An Example Application Developed in XphML Based on xPhoneApp

In this section an example of medical application developed in XphML using xPhoneApp for Shands Hospital of University of Florida is described. Two versions are used to illustrate how easy the extension of existing applications can be. The first version supports only navigation by clicking. The sophisticated second version can query patient information according to input data.

The First Version

The first version of the Shands application only allows doctors to view appointments on phones. The application starts from the home page,

apps.xml:
<?xml version=“1.0”?>
<apps>

<app version=“”
url=“http://www.domain.com/apps/med.xml”>Shands

HealthCare</app>

</apps>

The file med.xml of Version 1 is invoked by the home page apps.xml,

med.xml (version 1):
<?xml version=“1.0”?>
<screen_suite>

<screen name=“medmenu” type=“list”>

<list title=“Main Menu” type=“IMPLICIT”>

<item link=“http://www.domain.com/servlets/imed.appointment”>My

Appointments</item>

</list>
<cmds>

<cmd label=“choose” type=“OK” link=“LIST” />

</cmds>

</screen>

</screen_suite>

Here imed.appointment is a Java servlet on the server side that accepts parameters and generates the the XphML file that contains the requested information in a serious of screens screen_suite. This XML file is in the format following the xPhoneApp XphML specification. In this example to view “My Appointments”, the servlet imed.appointment will first get the appointment list from the database in the backend, next it generates the screen in XphML for displaying this appointment list, then the screens in XphML of the next level pointed from the appointment list screen will also be generated and the client will get all these XphML files together. This pre-fetching can save connection time that is relatively very high for wireless communication. In this way, doctors can click to the next screen for selecting patient information type very fast and choose to view patient information in details.

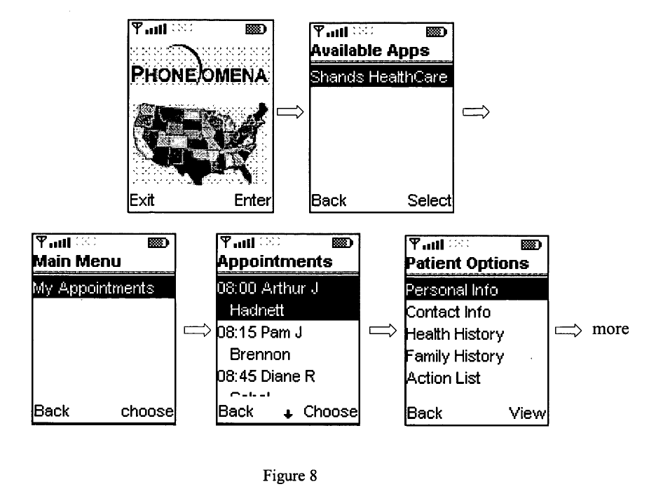

FIG. 8 shows several screens for Version I from the beginning, choosing the application, clicking the “My Appointments” choice, then the appointment list is shown, further patient information can be searched by information type, and more.

The Second Version

By the second version of the Shands application, doctors can search patient information by last name or social security number (SSN). The xPhoneApp Engine MIDlet on phone remain the same. The only change is to expand med.xml to its 2^{nd} version:

med.xml (version 2):
<?xml version=“1.0”?>

<screen_suite>

<screen name=“medmenu” type=“list”>

<list title=“Main Menu” type=“IMPLICIT”>

<item

link=“http://www.domain.com/servlets/imed.appointment”>

My Appointments</item>

<item link=“patient”>Patient Data</item>

</list>

<cmds>
<cmd label=“choose” type=“OK” link=“LIST” />
</cmds>

</screen>
<screen name=“patient” type=“form”>

<form title=“Patient Search”>

<choicegroup label=“Search by” param=“type”
type=“EXCLUSIVE”>

<choice>Last Name</choice>
<choice>SSN</choice>

</choicegroup>
<textfield label=“Search Text” param=“search”
maxsize=“10”

constraints=“ANY”></textfield>

</form>
<cmds>

<cmd label=“send” type=“OK”

link=“http://www.doman.com/servlets/imed.patientinfo” />

</cmds>

</screen>

</screen_suite>

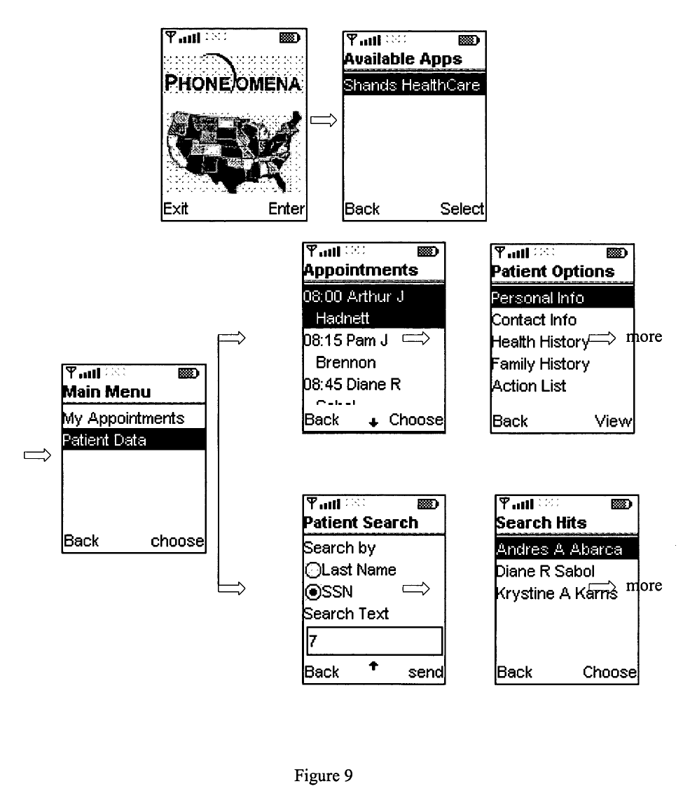

The new screen suite of Version 2 is shown in FIG. 9. Doctors can also choose “Patient Data” directly in the third screen and then provide either last name or SSN to search for patient information.

Here, the input can also be voice activated if the corresponding XphML lines include voiceEnable=true as:

<form title=“Patient Search”>

<choicegroup label=“Search by” param=“type”
type=“EXCLUSIVE”>

<choice>Last Name</choice>
<choice>SSN</choice>
</choicegroup>
<textfield label=“Search Text” param=“search”
maxsize=“10”

constraints=“ANY” voiceEnable=true></textfield>

</form>

This enables the xPhoneApp Engine to invoke local voice function on the client device to get voice data. Functionality like this cannot be supported by thin client approach in markeup languages such as WML, cHTML, or xHTML.

1.7.2 Elements for SupportingXphML

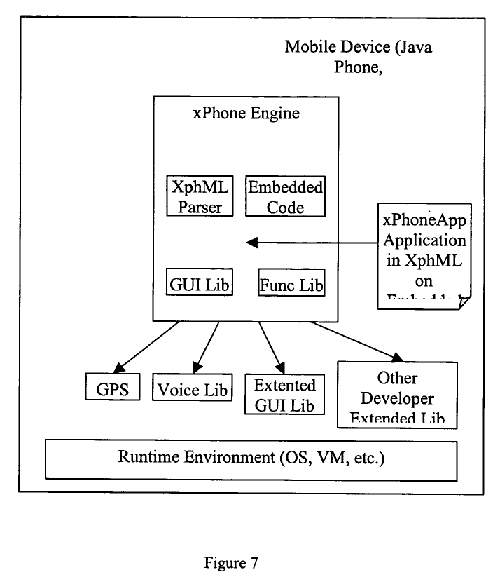

As FIG. 7 shows, client side should predefine standard core libraries of classes for objects: GUI Lib and Func Lib. Table 1 lists major xPhoneApp classes in the standard libraries. In the section of Appendix, there are more details about these classes.

TABLE 1
xPhoneApp Object Classes

| Class | XPhoneApp | | | |
|---|---|---|---|---|
| Category | Class | | | Description |
| Init and | XApplication | | | The main XAPP object that contains all |
| general: | | | | other XAPP objects as references. This |
| | | | | object knows how to read itself in from an |
| | | | | input stream and make the calls to other |
| | | | | objects so they also create themselves from |
| | | | | an input stream. |
| | | | | All commands for application are handled |
| | | | | in this class. |
| | XInitApp | | | Actions to take on startup |
| Common | XScreen | | | XAlert, XCanvas, XForm, XList, or |
| GUI | | | | XTextBox. |
| components | | | | This is an abstract class and cannot be |
| | | | | instantiated. |
| | | XCanvas | | A drawing canvas that can draw pixel by |
| | | | | pixel and catch low-level events such as |
| | | | | individual key presses and repaint requests. |
| | | XForm | | A list of items that can be text, image, |
| | | | | textfield, etc . . . |
| | | | XTextField | A text field where the user may enter data. |
| | | | | There will be a prompt, initial text string, |
| | | | | max length of field, and a mask constraint |
| | | | | on input. |
| | | | XChoice | A choice on an entry form like a radio |
| | | | | button or check box. The prompt text is |
| | | | | defined as well as the type of choice. |
| | | | XChoiceGroup | A group of choice containing an array of |
| | | | | XChoice objects. |
| | | | XStringItem | Defines a static String that can be displayed |
| | | | | on XForm or XAlert |
| | | | XImage | Defines an image usable within the XAPP |
| | | | | framework |

| | |
|---|---|
| XTextBox | A screen of editable text. |
| XTree | A component that organizes the items in a |
| | hierarch way. |
| XList | A list of items displayed as strings and the |
| | selected item found by calling the native |
| | API. |
| XAlert | An alert that can be brought to the attention |
| | of the user as well as the next screen in the |
| | application after the user dismissed the |
| | alert. If no screen, then next screen may be |
| | null. |

| | | |
|---|---|---|
| Command | XCommand | An event referenced by other parts of the |
| and | | application. There is a text string as well as |
| processing | | an array of XActions that accompany each |
| | | XCommand. |
| | XAction | Some action to perform. There will be a |
| | | predefined list of possible actions such as |
| | | going to another screen, obtaining a new |
| | | XML Application over the network, |
| | | popping up an alert or message box, etc . . . |
| | XDataStore | Defines an area of persistent storage on the |
| | | device and ways to work with it |

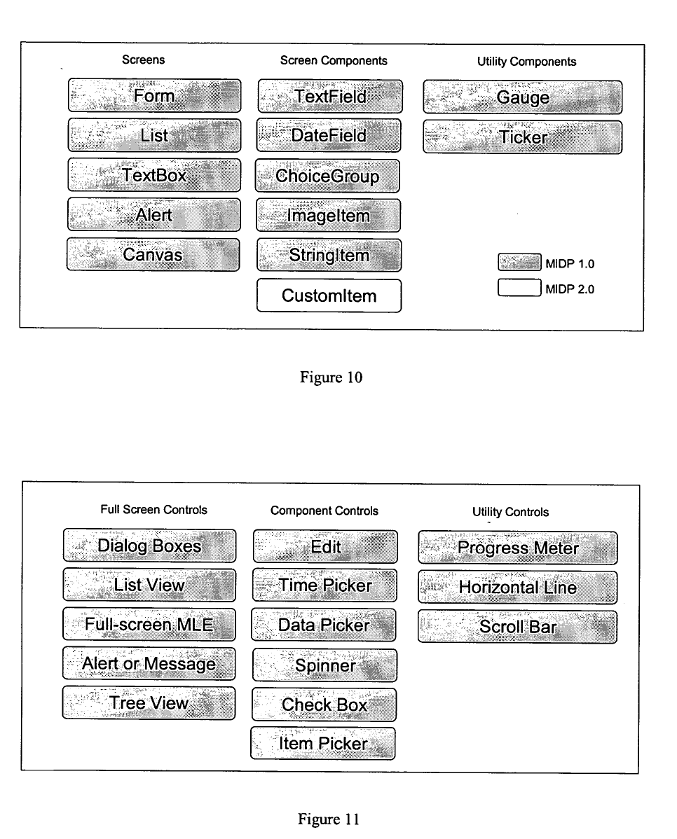

FIG. 10 and FIG. 11 show the GUI components of two smart phone application platforms: J2ME/MIDP and Microsoft Smartphone 2002. Despite slight difference, the GUI components of those two platforms are very similar. There is almost a one-to-one mapping relationship among those components. Therefore they can be integrated and their advantages can be combined into our xPhoneApp Engine with common object classes defined in the Table 1. Correspondingly, Table 2 illustrated how the tags in XphML are implemented by these components of J2ME/MIDP and Microsoft Smartphone Control. For the components that are not available natively in one platform, we implement them from scratch. For example Tree View is available in Microsoft Smartphone 2002, we can implement it using Canvas in J2ME/MIDP. Horizontal Line Separator can be implemented by ImageItem.

TABLE 2
xPhoneApp XML tags and corresponding GUI components

| | J2ME/MIDP | |
|---|---|---|
| XML Tag | GUI Component | Microsoft Smartphone Controls |
| form | Form | Dialog Boxes |
| list | List | List View |
| textbox | TextBox | Full-screen MLE |
| alert | Alert | Alert or Message Box |
| canvas | Canvas | |
| tree | | Tree View |
| textfield | TextField | Edit |
| datefield | DateField | Time Picker, Date Picker |
| choicegroup | ChoiceGroup | Spinner, Check Box, Item Picker |
| string | StringItem | Static |
| image | ImageItem | |
| gauge | Gauge | Progress Meter |
| ticker | Ticker | |
| hline | | Horizontal Line Separator |
| sbar | | Scroll Bar |

1.8 Phai Embedded Language—PhaiEmL

Phai Embedded Language PhaiEmL is an intermediate level language that is not used by developers directly. Application descriptions in XphML are compiled to PhaiEmL code which will be interpreted by xPhoneApp Engine on client side. Therefore, PhaiEmL should be machine friendly rather than human friendly for machine performance, not for human readability. Table 3 shows the mapping between XphML tags to corresponding PhaiEmL code values or links.

TABLE 3
xPhoneApp XphML tags and Correspondings in Phai Embedded Language Code

| Tag Name | Type | Bytes | Value |
|---|---|---|---|
| File Format ID | Integer | 4 | 0x0000ABCD (Xapplication) |
| Major Version | Short | 2 | 0x0001 |
| Minor Version | Short | 2 | 0x0000 |
| NumScreens | Integer | 4 | 0x00000002 |
| NumAlerts | Integer | 4 | 0x00000000 |
| NumCommands | Integer | 4 | 0x00000002 |
| NumActions | Integer | 4 | 0x00000002 |
| NumTextFields | Integer | 4 | 0x00000001 |
| NumChoices | Integer | 4 | 0x00000002 |
| NumChoiceGroups | Integer | 4 | 0x00000001 |
| Screens Data | XScreen | Variable | NumScreens * XScreen objects |
| Block | | | |
| Alerts Data | XScreen | Variable | NumScreens * Xalert objects |
| Block | | | |
| Commands Data | XScreen | Variable | NumScreens * XCommand objects |
| Block | | | |
| Actions Data | XScreen | Variable | NumScreens * XAction objects |
| Block | | | |
| TextFields Data | XScreen | Variable | NumScreens * XtextField objects |
| Block | | | |
| Choices Data | XScreen | Variable | NumScreens * XChoice objects |
| Block | | | |
| ChoiceGroups | XScreen | Variable | NumScreens * XChoiceGroup objects |
| Data Block | | | |
| Screen | Integer | 4 | 0x00009150 |
| Screen Type | byte | 1 | 0x10 (LIST) |
| Screen Name | Integer | 4 | 0x00000007 |
| Length | | | |
| Screen Name | Char[] | 7 | “medmenu” |
| List Title Name | Integer | 4 | 0x00000009 |
| Len | | | |
| List Title Name | Char[] | 9 | “Main Menu” |
| List Type | Byte | 1 | 0x01 (IMPLICIT) |
| NumItems | Integer | 4 | 0x00000002 |
| List Item | Integer | 4 | 0x00000010 |
| List Item Name | Integer | 4 | 0x00000010 |
| Len | | | |
| List Item Name | Char[] | 16 | “My Appointments” |
| List Item Link | Integer | 4 | 0x00000011 |
| List Item Link | Integer | 4 | 0x00000032 |
| Len | | | |
| List Item Link | Char[] | 52 | “http://www.domain.com/servlets/xubimed.appointment” |
| Command | Integer | 4 | 0x00000020 |
| Command Name | Integer | 4 | 0x00000004 |
| Len | | | |
| Command Name | Char[] | 4 | “send” |
| Screen | Integer | 4 | 0x00009150 |
| Screen Type | byte | 1 | 0x11 (FORM) |
| Screen Name | Integer | 4 | 0x00000007 |
| Length | | | |
| Screen Name | Char[] | 7 | “patient” |
| Form Title Name | Integer | 4 | 0x0000000E |
| Len | | | |
| Form Title Name | Char[] | 14 | “Patient Search” |
| Choice Group | Integer | 4 | 0x00000020 |
| Choice Group | Integer | 4 | 0x00000009 |
| Name Len | | | |
| Choice Group | Char[] | 9 | “Search by” |
| Name | | | |
| Choice Group | byte | 1 | 0x01 (EXCLUSIVE) |
| Type | | | |
| Num Choices | integer | 4 | 0x00000002 |
| Choice Name Len | Integer | 4 | 0x00000009 |
| Choice Name | Char[] | 9 | “Last Name” |
| Choice Name Len | Integer | 4 | 0x00000003 |
| Choice Name | Char[] | 7 | “SSN” |
| TextField | Integer | 4 | 0x00009250 |
| TextField Label | Integer | 4 | 0x0000000B |
| Len | | | |
| TextField Label | Char[] | 11 | “Search Text” |
| TextField Param | Integer | 4 | 0x00000006 |
| Length | | | |
| TextField Param | Char[] | 6 | “search” |
| TextField | Integer | 4 | 0x0000000A |
| MaxSize | | | |
| TextField | Byte | 1 | 0x02 (ANY |
| Constraints | | | |
| Command Name | Integer | 4 | 0x00000004 |
| Len | | | |
| Command Name | Char[] | 7 | “send” |
| Command Type | Byte | 1 | 0x03 (OK) |
| Command Link | Integer | 4 | 0x00000031 |
| Len | | | |
| Command Link | Char[] | 49 | “http://www.doman.com/servlets/xubimed.patientinfo” |

1.9 Development, Deployment, Installation Process
1.9.1 Development Process

Developers will write XphML scripts instead of writing programs in procedural programming languages for fat client application development. In rare cases if extended libraries are needed, developers can even extent XphoneApp Engine to include these libraries to support extended tags and features.

1.9.2 Deployment Process

The fat client applications are mostly in the forms of XphML or PharEmL. They will be deployed to servers for client to connect to. The XphoneApp Engine most be deployed for installation on all client devices first before every other XphML or PhaiEmL scripts. XphML and PhaiEmL scripts can be deployed to application providers' web site. Much less carrier involvement is required the fat client approach such as developed by J2ME.

1.9.3 Installation Process

Only xPhoneApp engine should be permanently stored on phones. Users will invoke new XphoneApp applications just as surf web. Usually, for application packages developed by procedural programming languages, installation can vary between applications and possible configuration usually annoying users. Applications by xPhoneApp approach totally avoid that.

2 xPhoneApp Object Classes

2.1 XApplication

The main xPhoneApp object that contains all other xPhoneApp objects as references. This object knows how to read itself in from an input stream and make the calls to other objects so they also create themselves from an input stream. Arrays of xPhoneApp objects are kept in this class and the maintenance of the entire application resides in this class. In addition, all command events for the application are handled in this class. Inner thread classes are available and threads are started to handle commands after being processed by the handler.

In general, an XApplication object should be able to:
1. Create itself from an input stream
2. Configure itself and start the initial screen
3. Gracefully handle all commands that occur during execution
4. Return control to the starting application when finished
   2.2 XScreen

A XScreen is a superclass of a XAlert, XCanvas, XForm, XList, or XTextBox. XScreen is abstract or an interface object that cannot be instantiated.

2.3 XAlert

This is an alert that can be brought to the attention of the user. This alert also contains a reference to the next XScreen in the application after the user dismisses the alert. If no next XScreen, then next XScreen reference may be null. We should include an optional sound to the alert that will be sounded when the alert becomes active.

In general, an XAlert object should be able to:
1. Create itself from an input stream
2. Display some text and an image
3. Produce a sound dependent on the alert type
4. Accept a “next XScreen” reference to display after the alert is responded to by the user
   2.4 XCanvas

If Canvas exists, then XCommands will be defined.

In general, an XCanvas object should be able to:
1. Create itself from an input stream
2. Draw a background color
3. Draw text at a certain location and with a certain font and color
4. Draw basic shapes with certain colors at certain locations
5. Respond to commands
6. Respond to certain key sequences
   2.5 XForm

A form will have commands defined that are independent of the items on the form, although the actions may reference items on the form.

In general, an XForm object should be able to:
1. Create itself from an input stream
2. Display different items in the form such as a text string, XTextField, and Ximage
3. Return the currently selected index or object reference
   2.6 XList

A List will have an array of text strings and XAction references defined for each item.

In general, a XList object should be able to:
1. Create itself from an input stream
2. Display a list of text strings
3. Return the currently selected index or text string
4. Return the XAction index reference into the global Xaction list
   2.7 XTextBox

An XTextBox is derived from XScreen and will display multiple lines of text to the user. The text may or may not be editable.

In general, a XTextBox object should be able to:
1. Create itself from an input stream
2. Display a text string to the user
3. Accept Xcommand references
4. Return the currently displayed text string
   2.8 XCommand

An XCommand is added to different XScreen components to be selected by the user during program execution.

In general, an XCommand object should be able to:
1. Create itself from an input stream
2. Contain a sequence of XAction objects to be executed when the command is selected within the program
   2.9 XTextField

In general, an XTextField object should be able to:
1. Create itself from an input stream
2. Display an initial text string to the user
3. Accept predefined masks that limit the type of character entry
4. Return the currently displayed text string
   2.10 XChoice

An XChoice object is a text string with a checkbox or radio button beside it for selection by the user.

In general, an XChoice object should be able to:
1. Create itself from an input stream
2. Accept a text string to display
3. Accept the type of choice it is (checkbox or radio button)
4. Return a boolean indicating checked or not checked
   2.11 XChoiceGroup

An XChoiceGroup will contain a list of XChoice objects

In general, an XChoiceGroup object should be able to:
1. Create itself from an input stream
2. Accept a list of XChoice objects
3. Return a list of currently selected choices in the group
   2.12 XDatastore

Defines an area of persistent storage on the device and ways to work with it.

In general, an XDataStore object should be able to:
1. Create itself from an input stream
2. Accept a list of byte arrays referenced by a string name
3. Return a byte array given a certain string name.
   2.13 XImage

Defines an image usable within the xPhoneApp framework.

In general, an XImage object should be able to:
1. Create itself from an input stream
2. Return a native image object given the mapping coordinates.

1. A system for application software development on mobile devices comprising;
a mobile device having a microprocessor and a memory;
means for downloading mobile device applications into the memory;
software programming means operable in the microprocessor for enabling development of further device applications and transfer of the further device applications into the memory; and
means in the mobile device for enabling operation of the device applications in the mobile device.

2. The system of claim I wherein the mobile device comprises a cellular phone.

3. The system of claim 2 wherein the mobile device includes a PDA.

4. The system of claim I wherein the software programming means comprises a MIDlet programming language.

5. The system of claim 4 wherein the means for downloading includes a means for converting Phai Script language to embedded code.
